(19) United States
(12) Patent Application Publication
(10) Pub. No.: US 2015/0193111 A1
(43) Pub. Date: Jul. 9, 2015

(54) Providing Intent-Based Feedback Information On A Gesture Interface

(71) Applicant: Google Inc., Mountain View, CA (US)

(72) Inventors: Alejandro Jose Kauffmann, San Francisco, CA (US); Christian Plagemann, Palo Alto, CA (US)

(73) Assignee: Google Inc., Mountain View, CA (US)

(21) Appl. No.: 14/042,977

(22) Filed: Oct. 1, 2013

(51) Int. Cl. G06F 3/0487; G06F 3/0482

(52) U.S. Cl. CPC G06F 3/0487; G06F 3/0482

(57) ABSTRACT

Described is a technique for providing intent-based feedback on a display screen capable of receiving gesture inputs. The intent-based approach may be based on detecting uncertainty from the user, and in response, providing gesture information. The uncertainty may be based on determining a pause from the user and the gesture information may include instructions that inform the user of the set of available input gestures. The gesture information may be displayed in one or menu tiers using a delay-based approach. Accordingly, the gesture information may be displayed in an informative and efficient manner without burdening the display screen.

### BACKGROUND

When providing a gesture-based interface, current systems are often designed based on traditional interface conventions. These systems usually take a literal approach by treating a hand as a pointer and often rely on traditional mouse and touch conventions. These traditional models often display distracting tracking objects on the screen and do not provide a suitable framework for designing a gesture interface. For example, there is a limited number of ways in which a user may interact with a touch screen or mouse, but there is potentially an unlimited number of ways to interact with a device using in-air gestures. Many gestural interfaces address this issue by assuming familiarity with the system or by utilizing front-heavy tutorials, both of which detract from an intuitive user experience.

### BRIEF SUMMARY

In an implementation, described is a method of providing gesture information on a display screen. The method may include detecting a raise hand movement and determining a pause of the raised hand. In response to the determined pause, a first menu displaying an instruction for an available input gesture may be provided on the screen. The method may also include detecting a drop hand movement and in response, the first menu may be removed from the screen. The method may also include providing, in response to the detected raise hand movement and prior to providing the first menu, a second menu on the screen displaying whether gesture inputs are available. The second menu may be displayed as a first menu tier and the first menu may be displayed as a second menu tier adjacent to the first menu tier. The first menu may be provided solely in response to the determined pause and irrespective of a tracked position of the hand to a position on the screen. When displaying a menu tier, a size of the first menu may be less than a size of a display area of the screen and an indicator responsive to a movement of the hand may be displayed only within the first menu. In addition, the screen may not include a cursor tracking a position of the hand to a position on the screen.

In an implementation, described is a method of providing gesture information on a display screen. The method may include detecting a first movement. In response to the detected first movement, a first menu tier may be provided on the screen. The first menu tier may display whether gesture inputs are available. The method may also include determining a first pause after the first movement and in response to the determined first pause, a second menu tier displaying an instruction for an available input gesture may be provided on the screen. The first movement may comprise a hand movement and the first movement may comprise only a portion of the available input gesture. The method may also include detecting a second movement after providing the second menu tier. The first movement and the second movement may complete the available input gesture and in response to the completed input gesture, the first menu tier and the second menu tier may be removed from the screen. In addition, the method may include determining a second pause after providing the second menu tier and in response to the determined second pause, a third menu tier displaying additional gesture information may be provided on the screen. The second pause may include the first pause. The method may also include detecting a second movement after the first pause and the second pause may occur after the second movement.

In an implementation, described is a device for providing gesture information on a display screen. The device may include a processor, and the processor may be configured to detect a raise hand movement and in response to the detected raise hand movement, a first menu tier may be provided on the screen. The first menu tier may display whether gesture inputs are available. The processor may also determine a first pause of the raised hand and in response to the determined first pause, a second menu tier displaying an instruction for an available input gesture may be provided on the screen. The first menu may be provided solely in response to the determined pause and irrespective of a tracked position of the hand to a position on the screen. When displaying a menu tier, a size of the first menu may be less than a size of a display area of the screen and an indicator responsive to a movement of the hand may be displayed only within the first menu.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a functional block diagram of a representative device according to an implementation of the disclosed subject matter.

FIG. 2 shows an example arrangement of a device capturing gesture input for a display screen according to an implementation of the disclosed subject matter.

FIG. 3 shows a flow diagram of providing gesture feedback information according to an implementation of the disclosed subject matter.

FIG. 4A shows an example of a display screen prior to detecting a gesture initiating movement according to an implementation of the disclosed subject matter.

FIG. 4B shows an example of a display screen displaying a first menu tier in response to a gesture initiating movement according to an implementation of the disclosed subject matter.

FIG. 5A shows an example of a display screen prior to determining a pause when a first menu tier is displayed according to an implementation of the disclosed subject matter.

FIG. 5B shows an example of a display screen displaying a second menu tier in response to a pause according to an implementation of the disclosed subject matter

FIG. 6 shows a flow diagram of providing gesture feedback information including additional menu tiers according to an implementation of the disclosed subject matter.

FIG. 7 shows an example of a display screen displaying additional menu tiers in response to a second pause according to an implementation of the disclosed subject matter.

### DETAILED DESCRIPTION

Described is a technique for providing intent-based feedback on a display screen capable of receiving gesture inputs. The intent-based approach may be based on detecting uncertainty from the user, and in response, providing gesture information. This gesture information may be in the form of instructions that inform the user of the available input gestures. In addition, this gesture information may be displayed in an informative and efficient manner without burdening the display screen. Rather than cluttering a display screen with icons, animations, camera views, etc., gesture information may be displayed in a tiered, delay-based approach. The tiered based approach allows the display interface to provide more specific feedback information as necessary. Accordingly, the techniques described herein, may provide the advantage of a consistent gesture discovery experience regardless of the particular set of available and/or allowable input gestures. This consistent experience allows even new users to easily interact with an unfamiliar system while at the same time preserving input speed and discoverability for advanced users.

The techniques described herein address a user's unfamiliarity with the system by detecting uncertainty from the user. Typically, a user may hesitate or pause when considering which gestures to perform or when the user is unsure of the available set of input gestures. Accordingly, the technique may determine a pause of the user's hand and may initiate a display of more specific feedback information. Current gesture interfaces often use a delay as an indication of certainty rather than uncertainty. For example, traditional gesture interfaces may include positioning a cursor that tracks a position of the user's hand over a display element for a certain amount of time (or “dwell” time) in order to execute a “click” or other “select” action. In contrast, techniques described herein may provide an input gesture without requiring a minimum delay, and accordingly, gesture inputs may be executed without sacrificing input speed.

For example, in an implementation, if a user wishes to interact with a gesture enabled device, all that may be required to initiate interaction is a raise hand movement. In response, the screen may display a first menu tier. The first menu tier may display whether input gestures are available. When a pause of the hand is determined, more specific feedback information may be displayed in a second menu tier. For example, the second menu tier may display instructions for specific input gestures that are available. If the hand is dropped or the user completes an input gesture, then one or more of the menu tiers may retreat or disappear. In situations where the user is familiar with an input gesture, the user may complete the input gesture in a fluid motion (e.g. without pausing) and menu tiers may not displayed or only appear only briefly (e.g. to indicate that an input gesture has been recognized). Thus, gesture inputs may be executed without delay or sacrificing input speed while still providing feedback information when necessary.

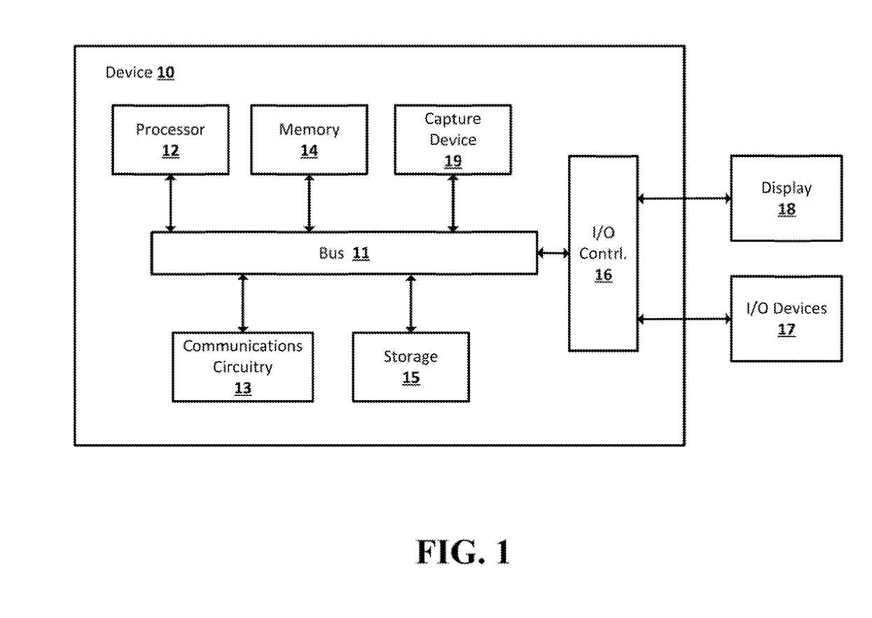

FIG. 1 shows a functional block diagram of a representative device according to an implementation of the disclosed subject matter. The device 10 may include a bus 11, processor 12, memory 14, I/O controller 16, communications circuitry 13, storage 15, and a capture device 19. The device 10 may also include or may be coupled to a display 18 and one or more I/O devices 17.

The device 10 may include or be part of a variety of types of devices, such as a set-top box, television, media player, mobile phone (including a “smartphone”), computer, or other type of device. The processor 12 may be any suitable programmable control device and may control the operation of one or more processes, such as gesture recognition as discussed herein, as well as other processes performed by the device 10. The bus 11 may provide a data transfer path for transferring between components of the device 10.

The memory 14 may include one or more different types of memory which may be accessed by the processor 12 to perform device functions. For example, the memory 14 may include any suitable non-volatile memory such as read-only memory (ROM), electrically erasable programmable read only memory (EEPROM), flash memory, and the like, and any suitable volatile memory including various types of random access memory (RAM) and the like.

The communications circuitry 13 may include circuitry for wired or wireless communications for short-range and/or long range communication. For example, the wireless communication circuitry may include Wi-Fi enabling circuitry for one of the 802.11 standards, and circuitry for other wireless network protocols including Bluetooth, the Global System for Mobile Communications (GSM), and code division multiple access (CDMA) based wireless protocols. Communications circuitry 13 may also include circuitry that enables the device 10 to be electrically coupled to another device (e.g. a computer or an accessory device) and communicate with that other device. For example, a user input component such as a wearable device may communicate with the device 10 through the communication circuitry 13 using a short-range communication technique such as infrared (IR) or other suitable technique.

The storage 15 may store software (e.g., for implementing various functions on device 10), and any other suitable data. The storage 15 may include a storage medium including various forms volatile and non-volatile memory. Typically, the storage 15 includes a form of non-volatile memory such as a hard-drive, solid state drive, flash drive, and the like. The storage 15 may be integral with the device 10 or may be separate and accessed through an interface to receive a memory card, USB drive, optical disk, a magnetic storage medium, and the like.

An I/O controller 16 may allow connectivity to a display 18 and one or more I/O devices 17. The I/O controller 16 may include hardware and/or software for managing and processing various types of I/O devices 17. The I/O devices 17 may include various types of devices allowing a user to interact with the device 10. For example, the I/O devices 17 may include various input components such as a keyboard/keypad, controller (e.g. game controller, remote, etc.) including a smartphone that may act as a controller, a microphone, and other suitable components. The I/O devices 17 may also include components for aiding in the detection of gestures including wearable components such as a watch, ring, or other components that may be used to track body movements (e.g. holding a smartphone to detect movements).

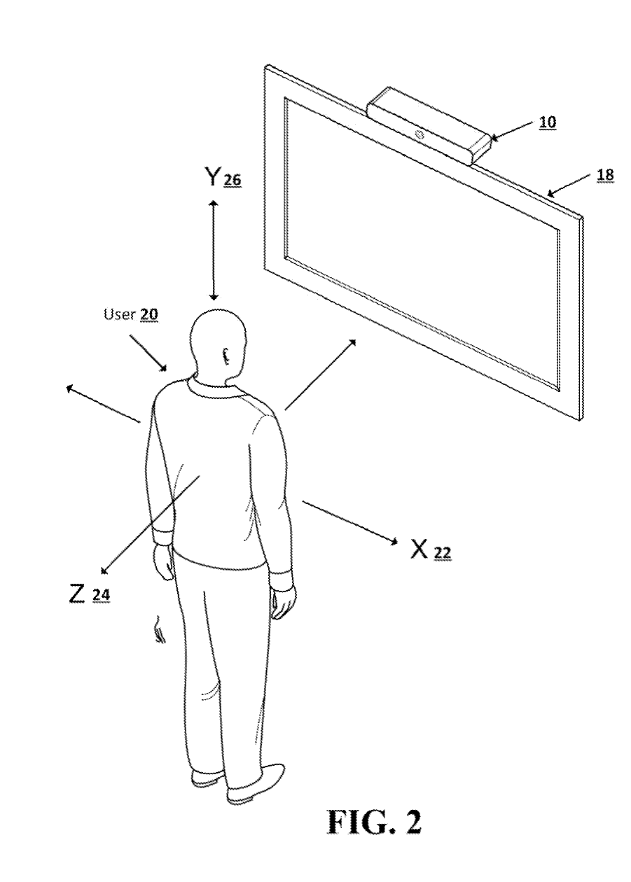

The device 10 may act a standalone unit that is coupled to a separate display 18 (as shown in FIGS. 1 and 2), or the device 10 may be integrated with or be part of a display 18 (e.g. integrated into a television unit). When acting as standalone unit, the device 10 may be coupled to a display 18 through a suitable data connection such as an HDMI connection, a network type connection, or a wireless connection. The display 18 may be any a suitable component for providing visual output as a display screen such as a television, computer screen, projector, and the like.

The device 10 may include a capture device 19 (as shown in FIGS. 1 and 2). Alternatively, the device 10 may be coupled to the capture device 19 through the I/O controller 16 in a similar manner as described with respect to a display 18. For example, the device 10 may include a remote device (e.g. server) that receives data from a capture device 19 (e.g. webcam or similar component) that is local to the user. The capture device 19 enables the device 10 to capture still images, video, or both. The capture device 19 may include one or more cameras for capturing an image or series of images continuously, periodically, at select times, and/or under select conditions. The capture device 19 may be used to visually monitor one or more users such that gestures and/or movements performed by the one or more users may be captured, analyzed, and tracked to detect a gesture input as described further herein.

The capture device 19 may be configured to capture depth information including a depth image using techniques such as time-of-flight, structured light, stereo image, or other suitable techniques. The depth image may include a two-dimensional pixel area of the captured image where each pixel in the two-dimensional area may represent a depth value such as a distance. The capture device 19 may include two or more physically separated cameras that may view a scene from different angles to obtain visual stereo data to generate depth information. Other techniques of depth imaging may also be used. The capture device 19 may also include additional components for capturing depth information of an environment such as an IR light component, a three-dimensional camera, and a visual image camera (e.g. RGB camera). For example, with time-of-flight analysis the IR light component may emit an infrared light onto the scene and may then use sensors to detect the backscattered light from the surface of one or more targets (e.g. users) in the scene using a three-dimensional camera or RGB camera. In some instances, pulsed infrared light may be used such that the time between an outgoing light pulse and a corresponding incoming light pulse may be measured and used to determine a physical distance from the capture device 19 to a particular location on a target.

FIG. 2 shows an example arrangement of a device capturing gesture input for a display interface according to an implementation of the disclosed subject matter. A device 10 that is coupled to a display 18 may capture gesture input from a user 20. The display 18 may include an interface that allows a user to interact with the display 18 or additional components coupled to the device 10. The interface may include menus, overlays, and other display elements that are displayed on a display screen to provide visual feedback to the user. The user 20 may interact with an interface displayed on the display 18 by performing various gestures as described further herein. Gesture detection may be based on measuring and recognizing various body movements of the user 20. Typically, the gesture may include a hand movement, but other forms of gestures may also be recognized. For example, a gesture may include movements from a user's arms, legs, feet, and other movements such as body positioning or other types of identifiable movements from a user. These identifiable movements may also include head movements including nodding, shaking, etc., as well as facial movements such as eye tracking, and/or blinking. In addition, gesture detection may be based on combinations of movements described above including being coupled with voice commands and/or other parameters. For example, a gesture may be identified based on a hand movement in combination with tracking the movement of the user's eyes, or a hand movement in coordination with a voice command.

When performing gesture detection, specific gestures may be detected based on information defining a gesture, condition, or other information. For example, gestures may be recognized based on information such as a distance of movement (either absolute or relative to the size of the user), a threshold velocity of the movement, a confidence rating, and other criteria. The criteria for detecting a gesture may vary between applications and between contexts of a single application including variance over time.

Gestures may include “in-air” type gestures that may be performed within a three-dimensional environment. In addition, these in-air gestures may include “touchless” gestures that do not require inputs to a touch surface. As described, the gesture may include movements within a three-dimensional environment, and accordingly, the gestures may include components of movement along one or more axes. These axes may be described as including an X-axis 22, Y-axis 24, and Z-axis 26. These axes may be defined based on a the typical arrangement of a user facing a capture device 19, which is aligned with the display 18 as shown in FIG. 2. The X-axis 22 may include movements parallel to the display 18 and perpendicular to the torso of the user 20. For example, left or right type movements such as a swiping motion may be along the X-axis 22. The Y-axis 24 may include movement parallel to the display 18 and parallel to the torso of the user 20. For example, up and down type movements such as a raise or lower/drop motion may be along the Y-axis 24. The Z-axis may include movement perpendicular to the display 18 and perpendicular to the torso of the user 20. For example, forward and back type movements such as a push or pull motion may be along the Z-axis 26. Movements may be detected along a combination of these axes, or components of a movement may be determined along a single axis depending on a particular context.

As shown, the device 10 may act as a standalone system by coupling the device 10 to a display 18 such as a television. With the integration of connectivity made available through the communications circuitry 13, the device 10 may participate in a larger network community.

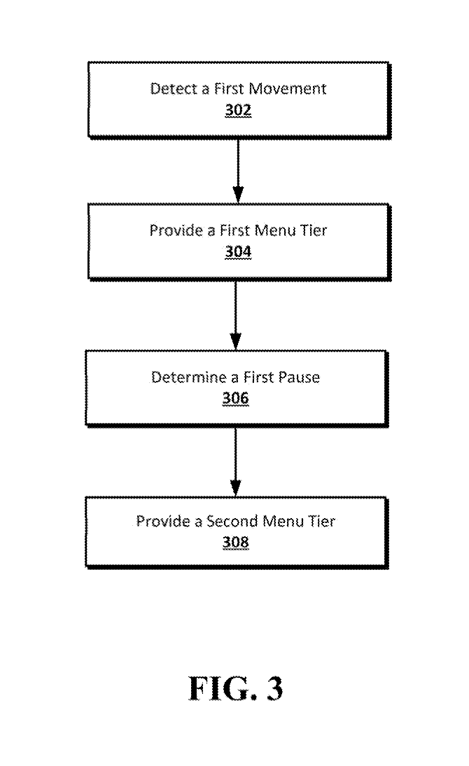

FIG. 3 shows a flow diagram of providing gesture feedback information according to an implementation of the disclosed subject matter. In 302, the device 10 may determine whether an activating or initiating movement is performed. The movement may include detecting a first movement such as a gesture. For example, in an implementation, the device may detect a raise hand gesture as initiating gesture input. The raise hand gesture, for example, may comprise a motion of a hand moving from a lower portion of the body to an upper portion of the body (e.g. shoulder height).

In 304, a first menu tier may be displayed in response to the detected first movement. The first menu tier may be provided on the display and may provide visual feedback to the user. In an implementation, the first menu tier may display information informing a user whether gesture inputs are available. A menu tier may be displayed on the screen in a manner that minimally burdens the display area. For example, a menu tier may be provided on only a portion of the display screen such as a menu bar. Menu tiers may also be displayed with varying transparency. For example, the menu may be semi-transparent to allow the user to see the screen elements behind the menu tier. The first menu tier may also be dynamic in response to the first movement. For example, with a raise hand movement, the menu tier may “scroll up” in a manner that corresponds to the movement and speed of the hand. Similarly, the menu tier may “scroll down” and retreat (or disappear) from the screen when the hand is dropped or lowered. The menu tier may also retreat after a completed gesture. The duration of displaying a menu tier on the screen may also be adapted based on the user's gesture. For example, when a user performs a gesture in a substantially fluid motion (e.g. without a detectable pause), the menu tier may be displayed only briefly to indicate that a gesture has been recognized, or not even appear at all. In addition, the menu tier may also be displayed for a minimum duration. For example, if a user immediately drops a hand after the menu tier is displayed, the menu tier may continue to display for a minimum duration (e.g. 2 to 3 seconds).

In 306, a device may determine a form of uncertainty from the user. The uncertainty may be determined based on determining a pause after the first movement. Often, a user may hesitate or pause when considering which gestures to perform or when the user is unsure of the available set of input gestures. Accordingly, the device may determine a pause of the user's hand and initiate a display of more specific feedback information. The pause may be determined immediately after a first movement has been recognized or after a predefined duration. For example, a pause of a raised hand may be determined in an instance where the user raises a hand to initiate a gesture, but due to uncertainty pauses because they are not aware of which gesture inputs are available. In order to determine a pause, the device may determine that a hand remains in a certain position for a certain duration. For example, the device may take into account minimal hand movements and determine whether a “still” position remains for predefined duration (e.g. 0.5 to 1.5 seconds). In addition, characteristics of a particular user may also be considered when determining a substantially still hand position. For example, when a gesture is attempted by certain users such as the elderly, the determination may need to include additional tolerances when determining if the user's hand remains still due to uncertainty. In addition, a pause may be determined based on an absence of movement. For example, after an initiation gesture (e.g. hand raise), the user may drop the hand and not complete a further movement. This may also be determined as uncertainty and initiate the display of additional information.

In 308, the device may provide a second menu tier in response to the determined uncertainty. For example, in response to determining a pause of a hand, a second menu tier may display gesture information. This gesture information may include information regarding available input gestures. In addition, information may include more specific information such as one or more instructions for available input gestures. These instructions may include text and visual cues informing the user on how to perform available gestures. The input gestures that are available may be based on the particular application, or context of an interface on the display. For example, during playback of multimedia, available gestures may relate to media controls (e.g. start/stop, forward, next, etc.). Accordingly, the menu tiers may display instructions for performing the particular media control gestures. In addition, the display of the menu may also be context based. For example, when a user is watching a movie, the menu tier may be even more minimal than in other situations. For example, only a portion of the menu tier may be displayed. By providing information in a tiered approach, information is displayed as necessary. In implementations, a single menu tier may only be displayed, and in such instances, instructions for an available input gesture may be displayed as a first menu tier.

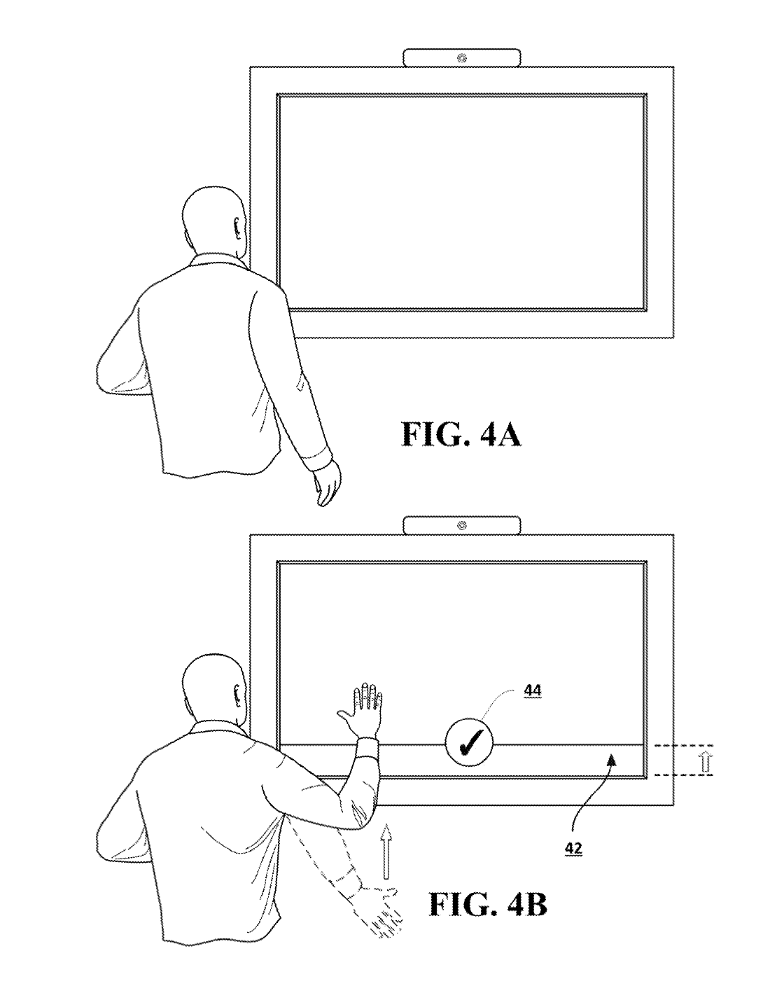

FIGS. 4A and 4B show a first menu tier being displayed after a gesture initiating movement. FIG. 4A shows an example of a display screen prior to detecting a gesture initiating movement according to an implementation of the disclosed subject matter. As described, the gesture initiating movement may include a hand raise movement. As shown in FIG. 4B, after a raise hand movement (or other predefined movement), a first menu tier 42 may be displayed. Menu tiers may be of varying sizes and may be located in various portions of the screen. As shown, the first menu tier 42 may include a menu bar displayed across a portion of the display screen. As shown, the first menu tier 42 may scroll up from the bottom of the screen in response to the detected hand raise movement. In this example, the menu tier is displayed across the bottom of the screen, but other locations may also be used such as the top or sides of the display screen. The menu tiers may display gesture feedback information, and in this example, the first menu tier 42 displays whether gesture inputs are available. The first menu tier 42 may display a gesture availability indicator 44 (e.g. check mark as shown) that informs the user that gesture inputs are available. Similarly, an “X,” or other symbol may inform the user that gesture inputs are not available. In another example, a green circle may indicate gestures inputs are available while a red crossed-through circle may indicate gestures inputs are not available. The gesture availability indicator 44 may include other suitable technique for providing information such as text information, other symbols, and the use of varying color combinations, etc.

The first menu tier 42 may also display other forms of gesture feedback information. For example, a menu tier may display feedback information upon detection of a movement including information on how to complete the gesture. For example, an indicator may inform the user that a swipe function is available, and upon commencement of a swipe movement, the indicator may provide feedback that a swipe movement has been recognized and provide an indication of when the swipe gesture has been completed. It should be noted that these indicators may differ from traditional pointers (e.g. cursors) that are manipulated by the gesture itself and constantly tracked to a position on the display screen. In contrast, these indicators may provide gesture feedback information without regard to tracked position of the hand to a particular mapped position on the display screen. For example, a raise hand gesture may be done in the center of the field of view of the capture device 19, or offset to the center of the field of view. When detecting the gesture, the device may only determine whether a hand raise gesture has been performed. In contrast, traditional pointer based gesture interfaces may require a user to position a cursor over a particular object or menu on the display screen. Moreover, in traditional systems these cursors may track a position of a hand to any position on the display screen. In an implementation described herein, a relative hand position may only be displayed within a particular menu tier. Moreover, movements may be limited to a particular axis and feedback information of the detected movement may be displayed only within a menu tier.

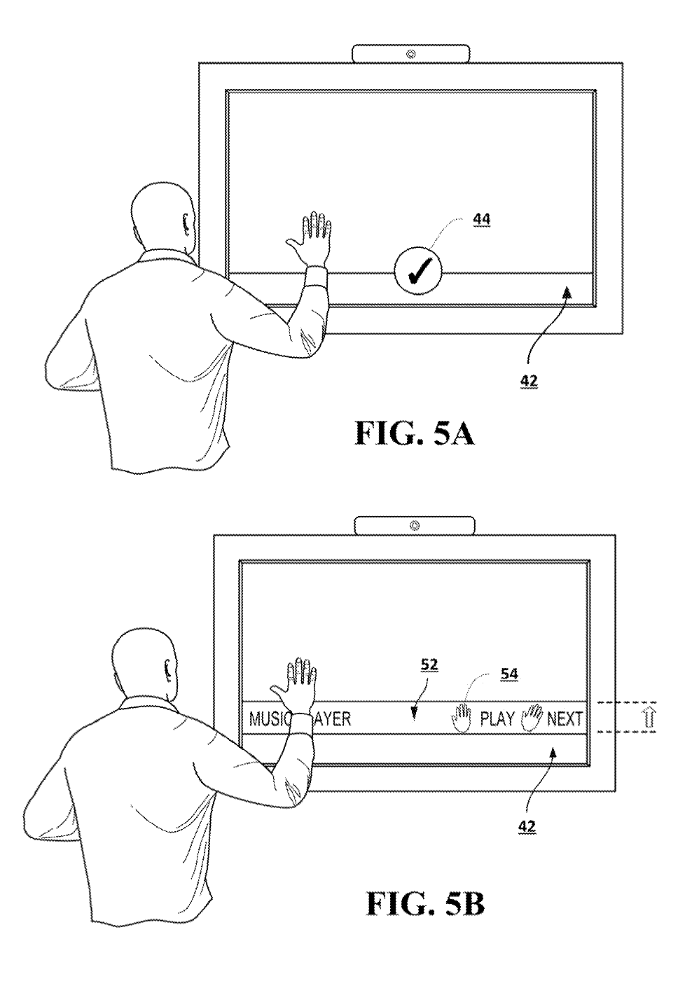

FIGS. 5A and 5B show a menu tier being displayed after a pause has been determined. FIG. 5A shows an example of a display screen prior to determining a pause when a first menu tier is displayed according to an implementation of the disclosed subject matter. As described above, a user's uncertainty may be determined based on determining a pause after a raise hand movement. In response to the determined pause, a menu tier may be displayed. As shown in FIG. 5B, a second menu tier 52 may be displayed in response to the determined pause. The second menu tier 52 may be displayed in a tiered manner, and as shown in this example adjacent to the first menu tier 42. The second menu tier 52 may include more specific information such as instructions for performing a gesture. In this example, the second menu tier 52 may include gesture instructions 54 indicating that a hand rotate gesture is available for a “next” command, and a push gesture is available for a “play” command. The available gestures may be context based according to a particular application. For example, as shown, the display interface relates to a music player, and accordingly, the available input gestures relate to navigation commands for the playback of music. The second menu tier 52 may also scroll up from the first menu tier 42. The display of additional tiers may be displayed in “waterfall” fashion wherein each tier scrolls up (or from another direction) from a previous menu tier. When a gesture is completed, the one or more menu tiers may retreat or disappear. As described above, implementations do not require the use of a cursor to be positioned in a specific location on a display screen for an input to be received. For example, in an implementation, a menu tier may be provided solely in response to a determined pause and irrespective of a tracked position of the hand to a position on the screen.

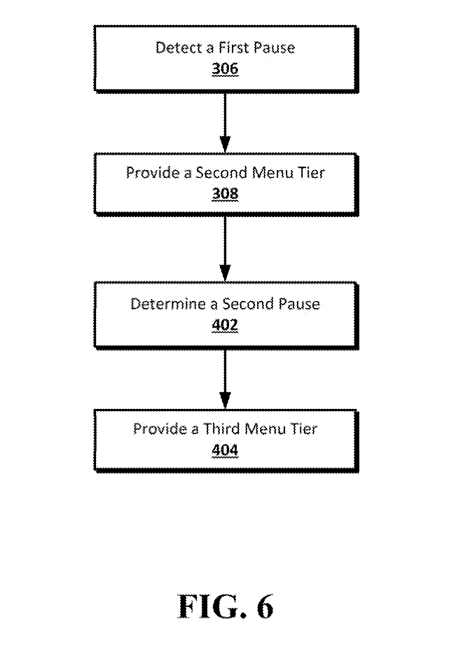

FIG. 6 shows a flow diagram of providing gesture feedback information including additional tiers according to an implementation of the disclosed subject matter. As described with respect to FIG. 3, a first pause may be determined in 306, and in response, a second menu tier may be provided in 308. In implementations, additional menu tiers may also be provided. In 402, a device 10 may determine a second pause in a similar manner as described in 306. In 404, the device 10 may provide a third menu tier (and additional tiers) in a similar manner as described in 308. The third menu tier (and additional tiers) may provide additional gesture information (e.g. contextual information) or increasingly specific gesture feedback information. In addition, the third menu tier may be provided not only in response to a second determined pause, but also in response to other criteria that may be context specific. For example, during a scrubbing command of media playback, additional information such as adjusting the speed of the scrubbing may be provided in an additional menu tier.

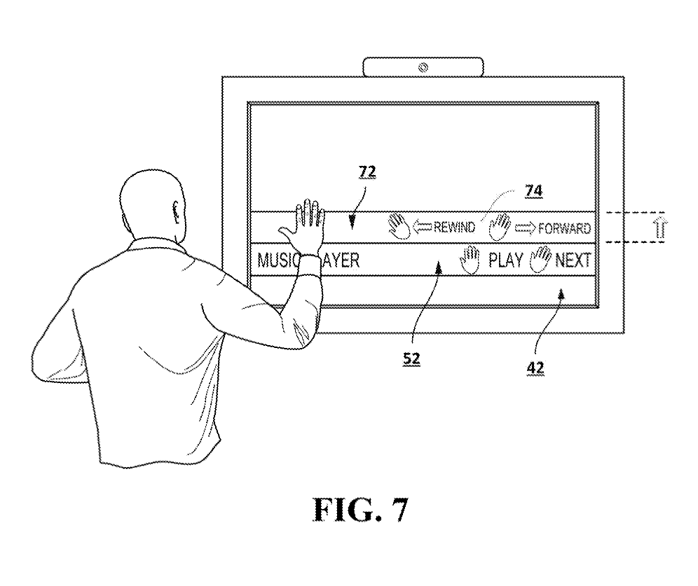

FIG. 7 shows an example of a display screen displaying additional menu tiers in response to a second pause according to an implementation of the disclosed subject matter. As described in FIG. 6, an additional pause or other action may be detected, and in response, additional menu tiers may be provided. As shown, a third menu tier 72 may be provided adjacent to the second menu tier 52. As shown, the third menu tier 74 may be provided in a “waterfall” type fashion. The third menu tier 72 may provide more specific information or additional gesture information. For example, as shown in FIG. 7, the third menu tier 72 may provide additional gesture information 74 including gesture instructions indicating that a hand swipe left gesture is available for a “rewind” command, and hand swipe right gesture is available for a “forward” command. As described, these additional commands are contextual based on the music player application.

Various implementations may include or be embodied in the form of computer-implemented process and an apparatus for practicing that process. Implementations may also be embodied in the form of a computer-readable storage containing instructions embodied in non-transitory and/or tangible memory and/or storage, wherein, when the instructions are loaded into and executed by a computer (or processor), the computer becomes an apparatus for practicing implementations of the disclosed subject matter.

Components such as a processor may be described herein as “configured to” perform various operations. In such contexts, “configured to” includes a broad recitation of structure generally meaning “having circuitry that” performs functions during operation. As such, the component can be configured to perform such functions even when the component is not currently on. In general, the circuitry that forms the structure corresponding to “configured to” may include hardware circuits such as general purpose processor, a field-programmable gate array (FPGA), an application specific integrated circuit (ASIC), and the like.

The flow diagrams described herein are included as examples. There may be variations to these diagrams or the steps (or operations) described therein without departing from the implementations described herein. For instance, the steps may be performed in parallel, simultaneously, a differing order, or steps may be added, deleted, or modified. Similarly, the block diagrams described herein are included as examples. These configurations are not exhaustive of all the components and there may be variations to these diagrams. Other arrangements and components may be used without departing from the implementations described herein. For instance, components may be added, omitted, and may interact in various ways known to an ordinary person skilled in the art.

References to “one implementation,” “an implementation,” “an example implementation,” and the like, indicate that the implementation described may include a particular feature, structure, or characteristic, but every implementation may not necessarily include the particular step, feature, structure, or characteristic. Moreover, such phrases are not necessarily referring to the same implementation. Further, when a particular step, feature, structure, or characteristic is described in connection with an implementation, such step, feature, structure, or characteristic may be included in other implementations whether or not explicitly described. The term “substantially” may be used herein in association with a claim recitation and may be interpreted as “as nearly as practicable,” “within technical limitations,” and the like.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
detecting, by a computing device, a raise-hand movement performed by a hand of a user;
determining, by the computing device, that the hand has moved less than a threshold amount during a specified period of time after completion of the raise-hand movement by the hand of the user;
determining that movement of the hand less than the threshold amount during the specified period of time after completion of the raise-hand movement does not correspond to a gesture; and
outputting, in response to determining that the movement of the hand less than the threshold amount during the specified period of time after completion of the raise hand movement does not correspond to a gesture, a first menu for display on a display screen, the first menu displaying an instruction for an available input gesture.

2. The method of claim 1, further comprising: detecting a drop-hand movement; and removing, in response to the detected drop-hand movement, the first menu from the display screen.

3. The method of claim 1, further comprising providing, in response to the detected raise-hand movement and prior to providing the first menu, a second menu on the display screen, the second menu displaying whether gesture inputs are available.

4. The method of claim 3, wherein the second menu is displayed as a first menu tier and the first menu is displayed as a second menu tier adjacent to the first menu tier.

5. The method of claim 1, wherein a size of the first menu is less than a size of a display area of the display screen, and an indicator responsive to a movement of the hand is displayed only within the first menu.

6. The method of claim 1, wherein the display screen does not include a cursor tracking a position of the hand to a position on the display screen.

7. The method of claim 1, wherein the first menu is provided solely in response to determining that the movement of the hand less than the threshold amount during the specified period of time after completion of the raise hand movement does not correspond to a gesture and irresepective of a tracked position of the hand to a position on the display screen.

8. A method comprising:
detecting, by a computing device, a first movement performed by a hand of a user;
providing, in response to the detected first movement, a first menu tier on the screen;
determining, by the computing device, that the hand has moved less than a threshold amount during a specified period of time after completion of the first movement by the hand of the user;
determining that movement of the hand less than the threshold amount during the specified period of time after completion of the first movement does not correspond to a gesture; and
outputting, in response to determining that movement of the hand less than the threshold amount during the specified period of time after completion of the first movement does not correspond to a gesture, a second menu tier for display on a display screen, the second menu tier displaying an instruction for an available input gesture.

9. The method of claim 8, wherein the first movement comprises a hand movement.

10. The method of claim 8, wherein the first movement comprises only a portion of the available input gesture.

11. The method of claim 8, wherein the first menu tier displays whether gesture inputs are available.

12. The method of claim 8, further comprising: detecting a second movement after providing the second menu tier, wherein the first movement and the second movement complete the available input gesture; and removing, in response to the completed input gesture, the first menu tier and the second menu tier from the display screen.

13. The method of claim 8, further comprising determining, by the computing device, that the hand has moved less than the threshold amount during a second specified period of time after completion of a second movement by the hand of the user after providing the second menu tier;
determining that movement of the hand less than the threshold amount during the second specified period of time after completion of the second movement does not correspond to a gesture; and
providing, in response to determining that movement of the hand less than the threshold amount during the second specified period of time after completion of the second movement does not correspond to a gesture, a third menu tier on the display screen, the third menu tier displaying additional gesture information.

14. The method of claim 13, wherein the determining that the hand has moved less than the threshold amount during the second specified period of time includes the determining that the hand has moved less than the threshold amount during the first specified period of time.

15. The method of claim 13, further comprising detecting a second movement after the determining that the hand has moved less than the threshold amount during the first specified period of time, and wherein the determining that the hand has moved less than the threshold amount during the second specified time period occurs after the second movement.

16. A device comprising;
a processor, the processor configured to:
detect a raise-hand movement performed by a hand of a user;
provide, in response to the detected raise hand movement, a first menu tier on the screen;
determine that the hand has moved less than a threshold amount during a specified period of time after completion of the raise-hand movement by the hand of the user;
determine that movement of the hand less than the threshold amount during the specified period of time after completion of the raise-hand movement does not correspond to a gesture; and
output, in response to determining that movement of the hand less than the threshold amount during the specified period of time after completion of the raise-hand movement does not correspond to a gesture, a second menu tier for display on a display screen, the second menu tier displaying an instruction for an available input gesture.

17. The device of claim 16, wherein the first menu tier displays whether gesture inputs are available.

18. The device of claim 16, wherein the raise-hand movement comprises only a portion of the available input gesture.

19. The device of claim 16, wherein a size of the first menu tier is less than a size of a display area of the display screen, and an indicator responsive to a movement of the hand is displayed only within the first menu tier.

20. The device of claim 16, wherein the first menu tier is provided solely in response to determining that movement of the hand less than the threshold amount during the specified period of time after completion of the raise-hand movement does not correspond to a gesture pause and irrespective of a tracked position of the hand to a position on the display screen.
